(19) United States
(12) Patent Application Publication
(10) Pub. No.: US 2022/0011922 A1
(43) Pub. Date: Jan. 13, 2022

(54) Instant Ideograms Method and System

(71) Applicant: Abraham Varon-Weinryb, Waltham, MA (US)

(72) Inventor: Abraham Varon-Weinryb, Waltham, MA (US)

(21) Appl. No.: 17/361,260

(22) Filed: Jun. 28, 2021

Related U.S. Application Data
(60) Provisional application No. 63/076,836, filed on Sep. 10, 2020.
(60) Provisional application No. 63/045,333, filed on Jun. 29, 2020.

(51) Int. Cl. G06F 3/0481; H04M 1/72436; H04N 5/232; H04L 12/58; G06F 3/0488

(52) U.S. Cl. CPC G06F 3/04817; H04M 1/72436; G06F 3/04847; H04L 51/046; G06F 3/04883; H04N 5/23222

(57) ABSTRACT

The invention relates to a communication-over-the-internet method and system in which ideograms which are implemented within a software application are being sent over the internet from a sending user to a second user's device in order to provide specific instructions to said second user.

### CROSS REFERENCE TO RELATED APPLICATIONS

This application claims benefit of provisional application 63/076,836 filed on Sep. 10, 2020.

This application claims benefit of provisional application 63/045,333 filed on Jun. 29, 2020.

### FIELD OF THE INVENTION

The field of the invention relates to a method and system for interaction between two people, each using a computing device, over the internet. The invention introduces new ways to transfer instant commands over the internet.

### BACKGROUND OF THE INVENTION

In my Provisional application named “Visit Via Taker Method and System”, U.S. 63/045,333 dated Jun. 29, 2020 Filing Receipt Confirmation Number 1269, a system and method of video streaming and of services via the internet is claimed. In said U.S. 63/045,333, a Customer (also referred to as a Visitor) “A” interacts with a Taker “B” which “takes” the customer for a visit. The Taker can virtually take the Customer to any place in the world, at any date and time. Said services will be active by nature, meaning that said Customer is not only passively taken wherever the Taker goes, but the Customer also actively instructs the Taker where to go. Such instructions can be provided via known interaction mechanisms such as voice and chat. However, there are known limitations for such interaction methods. Chat is relatively time consuming and requires both the Customer and the Taker being able to read and to write using the same language. Voice communication has its own challenges such as interfering background noises, broadcasting interference and language barriers.

It is therefore an object of the present invention to provide additional new ways for transfer of instructions between two people over the internet.

It is therefore an object of the present invention to provide innovative way for interaction between two people over the internet in a way that overcomes and bypasses many of said limitations relating to voice communication and to chat communication.

It is therefore a particular object of the present invention to provide innovative way for a Visitor—Taker interaction in a way that ultimately lead to a better Video Product and to higher satisfaction rate of both the Visitor and the Taker.

### SUMMARY OF THE INVENTION

The invention relates to a communication-over-the-internet method and system in which Instant Ideograms which are implemented within a software application are being sent over the internet from a sending user using a device with said software application to a second user's device in order to provide specific instructions to said second user.

Preferably, said Instant Ideograms are Control Icons.

Preferably, said Instant Ideograms are Sketch Gestures.

Preferably, said Instant Ideograms are free hand Sketched letters, words, or sentences.

Preferably, said Instant Ideograms are instructions to move forward or backwards or to the left or to the right or to stop.

Preferably, said Instant Ideograms are instructions to move faster or slower.

Preferably, said Instant Ideograms are instructions to focus on an object.

Preferably, said Instant Ideograms are instructions to zoom in or zoom out with a mobile device's camera.

Preferably, said Instant Ideograms are used by a Visitor to instruct a Taker.

Preferably, said Instant Ideograms eliminate completely the use of a voice communication.

Preferably, said Instant Ideograms eliminate completely the use of a chat communication.

Preferably, said Instant Ideograms are complementary to a voice communication or to a chat communication.

Preferably, said sending user's device is a mobile device.

Preferably, said sending user's mobile device is a smartphone.

Preferably, said sending user's mobile device is a tablet.

Preferably, said sending user's device is a computer.

Preferably, said second user's device is a mobile device.

Preferably, said second user's mobile device is a smartphone.

Preferably, said second user's mobile device is a tablet.

Preferably, said second user's device is a computer.

Preferably, said users can replace roles meaning that the second user can act as a sending user and the sending user can function as the second user so that said communication is bi-directional and each of said users can provide instructions to the other using said Instant Ideograms.

### BRIEF DESCRIPTION OF THE DRAWINGS

In the drawings:

FIG. 1 shows two typical layouts of a mobile device of a person who sends Instant Ideograms according to the invention and of the corresponding recipient side—a mobile device of a person who receives such Instant Ideograms.

FIG. 2 shows an example for a sequence of communication over the internet between two persons, in which Instant Ideograms are used in addition to traditional voice and chat communications.

### DETAILED DESCRIPTION OF PREFERRED EMBODIMENTS

As my U.S. 63/045,333 application introduces a new concept of a video streaming which is active and in which the person who takes the video receives instruction from the person who consumes the video, there is a place and a need for additional and better communication mechanisms, in addition to voice and chat. Chat is time consuming, it relatively requires a lot of effort and attention, and it is also subject to language barriers. Voice communication is limited in loud areas, subject to broadcast interference, relatively takes a lot of time and is also subject to language barriers. Therefore, this invention introduces a new way of providing instructions over the internet using Instant Ideograms, also refereed to in this document as Control Icons, and also Instant Ideograms in a way of Sketching Gestures.

When chatting, people already use emojis to express their emotions. But this invention is not about transferring emotions but about providing strict and specific instructions, in a way that is not only complementary to voice and to chat, but can also totally replace voice and chat in some cases and provide complex sets of instructions relating to required actions. Example for said instructions will be provided hereby in the context of a Taker—Visitor interaction according to U.S. 63/045,333, but other sets of instructions can be used as Control Icons or Instant Ideograms according to the invention, in many cases which involve interaction between to persons over the internet and which relates to providing any service or participating in any joint activity over the internet.

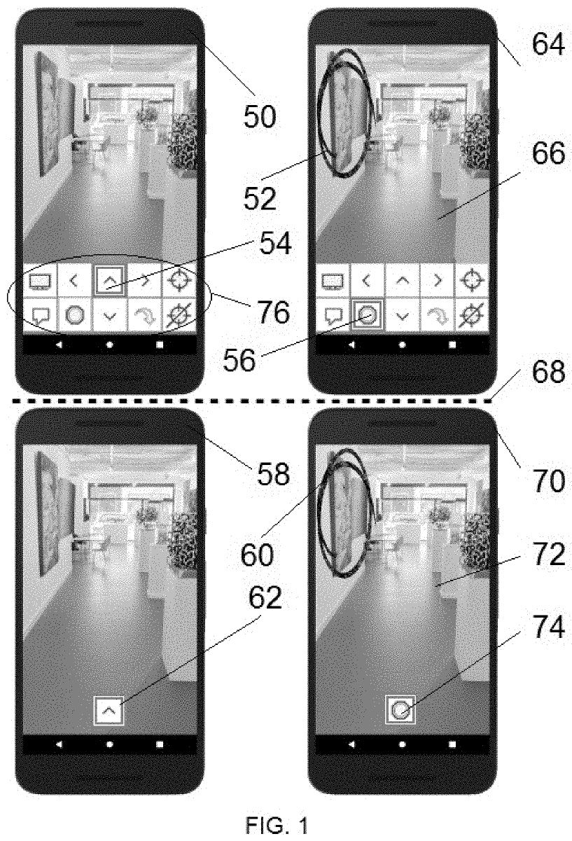

FIG. 1 shows, above dashed line (68), two typical layouts of a mobile device of a person who sends Instant Ideograms according to the invention. FIG. 1 shows, beyond dashed line (68), the corresponding recipient side—two typical layouts of a mobile device of a person who receives such Instant Ideograms.

Shown on mobile device (50) are 10 Control Icons (76). Such Control Icons may be customizable, meaning the user may add and remove Control Icons upon need. 10 Control Icons are visible here. If there are more Control Icons, the user may bring them using a slide gesture to the left or to the right over the Control Icons. If the user wants to temporarily hide the Control Icons, he may do it using a slide gesture to the bottom, and the user may bring them back using a slide gesture to the top.

As shown in device (50), the Control Icon of arrow up (\hat{ }) is marked or highlighted. This means that the first user, which is a Visitor in this case according to U.S. 63/045,333, selected this Control Icon by touching it. As a result, the recipient mobile device (58) of a second user, which is a Taker in this case according to U.S. 63/045,333, displays this Control Icon (62). So now said Taker knows that he is expected to move forward. While he moves forward, and according to this scenario which is related to U.S. 63/045,333 by means of example, his video streaming is being sent to the Visitor's device (shown above dashed line (68)). Now, suppose that the Visitor presses the STOP Control Icon (56). As a result, a STOP Control Icon (4) pops up at the Taker's device (70). As a result, the Taker will stop. Now, the Visitor draws a circle (52) on the screen using his finger. This is a sketched Gesture—a free form sketch, a round circle in this case, that enables the Visitor to show an area on the streamed video which he finds interesting—in this example a painting hanging on the wall. As a result, the Taker can move closer to the painting and let the visitor see it closely and clearly (not shown in FIG. 1).

Therefore, the Control Icons and Sketched Gestures provide a very fast, convenient and optimized way to provide clear instructions in a most efficient way and while bypassing various potential obstacles.

The method of the invention will be farther explained and demonstrated hereby with an example.

### Example 1

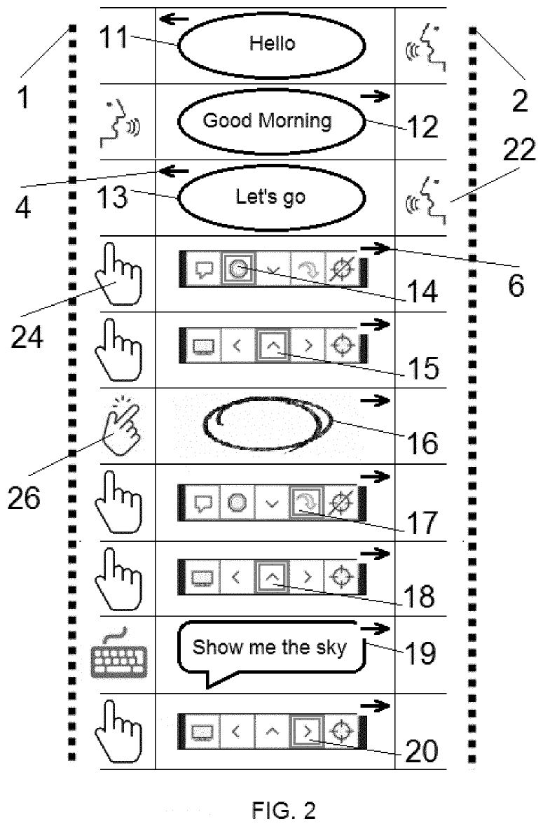

FIG. 2. illustrates, top down, a sequence of 10 sequential interactions between 2 persons, in this example a Visitor and a Taker according to U.S. 63/045,333. Said interactions are delivered from the Visitor's end (1) to the Taker's end (2), and vise versa. A communication in the context of this example may be voice communication (22), chat communication (19), and the new types of communications according to the invention: Instant Ideogram of a Control Icon (24) or Instant Ideogram of a Sketched Gesture (26). This example's sequence of communications includes 3 voice interactions, 1 chat interaction, and 6 of the new types of interactions according to the invention, of which 5 are Control Icons and 1 is a sketched Gesture. An arrow to the right (6) indicates a communication from the Visitor to the Taker and an arrow to the left (4) indicates a communication from the Taker to the Visitor. Here's the communication's sequence:
(a) Voice. Taker to Visitor. Description: The Taker says “Hello” (11)
(b) Voice. Visitor to Taker. Description: The Visitor says, “Good Morning” (12)
(c) Voice. Taker to Visitor. Description: The Taker says, “Let's go” (13). At this point the Taker starts walking forward.
(d) Instant Ideogram of a Control Icon. Visitor to Taker. Description: The Visitor presses the “STOP” Control Icon (14). When this Icons pops up at the Taker's screen, he immediately stops walking.
(e) Instant Ideogram of a Control Icon. Visitor to Taker. Description: The Visitor presses the “\hat{ }” Control Icon (15). When this Icons pops up at the Taker's screen, he starts walking forward again.
(f) Instant Ideogram of a Sketched Gesture. Visitor to Taker. Description: The Visitor sketches a circle with his finger (16), around an object or an area at the streaming video's shown on the screen of the Visitor's mobile device. When this circle pops up at the same location at the Taker's screen, he moves towards said object or area and focuses on it.
(g) Instant Ideogram of a Control Icon. Visitor to Taker. Description: The Visitor presses the “ROTATE” Control Icon (17). When this Icons pops up at the Taker's screen, he rotates the mobile device, i.e. switching from portrait to landscape or from landscape to portrait.
(h) Instant Ideogram of a Control Icon. Visitor to Taker. Description: The Visitor presses the “\hat{ }” icon (18). When this Icons pops up at the Taker's screen, he starts walking forward again if he has stopped, or just continues moving forward.
(i) Chat. Visitor to Taker. Description: The Visitor types “Show me the sky” (19). This is an example for something that does not have a dedicated Control Icon for, according to this example. Therefore, the Visitor needs to use voice again or a chat, as in this case. However, instead, it is also possible to use a free handwriting of text on the screen as a type of Instant Ideogram of a Sketched Gesture.
(j) Instant Ideogram of a Control Icon. Visitor to Taker. Description: The Visitor presses the “>” icon (20). When this Icons pops up at the Taker's screen, he turns right.

While some embodiments of the invention have been described by way of illustration, it will be apparent that the invention can be put into practice with many modifications, variations and adaptations, and with the use of numerous parameters that are within the scope of persons skilled in the art, without departing from the spirit of the invention or exceeding the scope of the claims.

1. A communication-over-the-internet method and system in which Instant Ideograms which are implemented within a software application are being sent over the internet from a sending user using a device with said software application to a second user's device in order to provide specific instructions to said second user.

2. Method according to claim 1 in which said Instant Ideograms are Control Icons.

3. Method according to claim 1 in which said Instant Ideograms are Sketch Gestures.

4. Method according to claim 1 in which said Instant Ideograms are free hand Sketched letters, words, or sentences.

5. Method according to claim 1 in which said Instant Ideograms are instructions to move forward or backwards or to the left or to the right or to stop.

6. Method according to claim 1 in which said Instant Ideograms are instructions to move faster or slower.

7. Method according to claim 1 in which said Instant Ideograms are instructions to focus on an object.

8. Method according to claim 1 in which said Instant Ideograms are instructions to zoom in or zoom out with a mobile device's camera.

9. Method according to claim 1 in which said Instant Ideograms are used by a Visitor to instruct a Taker.

10. Method according to claim 1 in which said Instant Ideograms eliminate completely the use of a voice communication.

11. Method according to claim 1 in which said Instant Ideograms eliminate completely the use of a chat communication.

12. Method according to claim 1 in which said Instant Ideograms are complementary to a voice communication or to a chat communication.

13. Method according to claim 1 in which said sending user's device is a mobile device.

14. Method according to claim 13 in which said mobile device is a smartphone.

15. Method according to claim 13 in which said mobile device is a tablet.

16. Method according to claim 1 in which said sending user's device is a computer.

17. Method according to claim 1 in which said second user's device is a mobile device.

18. Method according to claim 17 in which said mobile device is a smartphone.

19. Method according to claim 17 in which said mobile device is a tablet.

20. Method according to claim 1 in which said second user's device is a computer.

21. Method according to claim 1 in which said users can replace roles meaning that the second user can act as a sending user and the sending user can function as the second user so that said communication is bi-directional and each of said users can provide instructions to the other using said Instant Ideograms.
